(19) United States
(12) Patent Application Publication
(10) Pub. No.: US 2016/0237281 A1
(43) Pub. Date: Aug. 18, 2016

(54) PHOTOCURABLE RESIN COMPOSITION, IMAGE DISPLAY DEVICE AND METHOD FOR MANUFACTURING IMAGE DISPLAY DEVICE

(71) Applicant: HITACHI CHEMICAL COMPANY, LTD., Tokyo (JP)

(72) Inventors: Yuuki MIYAMOTO, Hitachi-shi, Ibaraki (JP); Youichi KIMURA, Chiba-shi, Chiba (JP); Tetsuya OKAZAKI, Hitachi-shi, Ibaraki (JP); Hiroka SHINDOU, Hitachi-shi, Ibaraki (JP); Masayuki WADA, Hitachi-shi, Ibaraki (JP); Tomohiro HORINOUCHI, Hitachi-shi, Ibaraki (JP)

(21) Appl. No.: 15/025,621

(22) PCT Filed: Sep. 26, 2014
(86) PCT No.: PCT/JP2014/075613

§ 371 Date: Mar. 29, 2016

(30) Foreign Application Priority Data
Sep. 30, 2013 (JP) 2013-205939

(51) Int. Cl. C09D 4/00; C09D 7/12; C09D 5/00

(52) U.S. Cl. CPC C09D 4/00; C09D 5/00; C09D 7/125; C09D 7/1241

(57) ABSTRACT

The present invention relates to a photocurable resin composition including (A) a compound having (meth)acryloyl group, (B) a photopolymerization initiator, and (C) a plasticizer, a content of the photopolymerization initiator (B) being 4.0 to 10% by mass.

### TECHNICAL FIELD

The present invention relates to a photocurable resin composition, an image display device using the same, and a method for manufacturing an image display device.

### BACKGROUND ART

Image display devices, for example, liquid crystal display panels used for information terminals, such as smartphones, etc. are manufactured by a method of arranging a photocurable resin composition between an image display member, such as a liquid crystal display panel, an organic EL panel, etc., and a light-transmitting cover member, and curing the composition upon irradiation with an ultraviolet ray to prepare a light-transmitting cured resin layer, to thereby perform adhesion and lamination of the image display member and the light-transmitting cover member (PTL 1).

Now, in order to improve brightness and contrast of a display image, a light-shielding layer is provided on the periphery of the surface of the light-transmitting cover member on the image display member side. There may be the case where the irradiation to the photocurable resin composition sandwiched between the light-shielding layer and the image display member with an ultraviolet ray becomes insufficient due to the presence of the light-shielding layer, so that curing does not sufficiently proceed. As a result, a sufficient adhesive force between the members is not obtained, and there is a concern that delamination between the light-transmitting cover member and the image display member, reduction of image quality due to invasion of moisture into a gap thereof, or the like is generated.

Then, there is proposed a method in which a photocurable resin composition is compounded with a thermopolymerization initiator to prepare a thermosetting and photocurable resin composition, the thermosetting and photocurable resin composition is coated on a surface of a light-transmitting cover member having a light-shielding layer formed thereon, the coated surface is placed on an image display member and subjected to photocuring upon irradiation with an ultraviolet ray, and the whole is then heated to thermally cure the thermosetting and photocurable resin composition sandwiched between the light-shielding layer and the image display member (PTL 2).

In addition, there is proposed a method in which a liquid photocurable resin composition not containing a thermopolymerization initiator is coated on a surface of a light-transmitting cover member having a light-shielding layer formed thereon or a surface of an image display member and then irradiated with an ultraviolet ray in that state to achieve pre-curing, the image display member and the light-transmitting cover member are laminated via the pre-cured resin layer, and the resultant is then irradiated with an ultraviolet ray to achieve complete curing, thereby forming a light-transmitting cured resin layer (PTL 3).

### CITATION LIST

### Patent Literature

PTL 1: WO 2010/027041A

PTL 2: WO 2008/126860A

PTL 3: Japanese Patent No. 5138820

### SUMMARY OF INVENTION

### Technical Problem

However, according to the technique of PTL 2, though dissolution of the problem concerned in PTL 1 could be expected, because of use of a combination of a photopolymerization initiator and a thermopolymerization initiator, a thermopolymerization process must be carried out in addition to the photopolymerization process. In consequence, there were involved such problems that a burden on equipment investment for the thermopolymerization process becomes large; and that the storage stability of the thermosetting and photocurable resin composition is reduced.

In addition, according to the technique of PTL 3, though dissolution of the problem concerned in PTL 2 could be expected, since the photocurable resin composition sandwiched between the light-shielding layer and the image display member is stuck in a semi-cured state after going through the pre-curing step, there is a concern about the generation of air bubbles from between the light-shield layer and the surface of the light-transmitting cover member, or the generation of delamination between the light-transmitting cover and the photocurable resin composition. In addition, during a period after sticking in a semi-cured state and before the complete curing step, there is a concern about the generation of position deviation between the light-transmitting cover and the photocurable resin composition to be caused due to liquid floated from the photocurable resin composition. Furthermore, after sticking of the light-transmitting cover member and the image display member to each other, photocuring by means of irradiation with an ultraviolet ray is further performed to achieve adhesion, and hence, there is involved such a problem that a burden on equipment investment for the complete curing process becomes large.

A problem of the present invention is to solve the aforementioned problems of the conventional techniques. That is, an object of the present invention is to provide a photocurable resin composition which is suitable for filling a space between a light-transmitting cover member, such as a protective panel, etc., and an image display member, etc. in an image display device, is able to inhibit liquid floating after photocuring by means of irradiation with an active energy ray in a pre-step of sticking the light-transmitting cover member and the image display member to each other, exhibits a sufficient adhesive force, and is able to contemplate to simplify a manufacturing step, an image displayer device using the same, and a method for manufacturing the image display device.

### Solution to Problem

In order to solve the aforementioned problem, the present inventors made extensive and intensive investigations. As a result, it has been found that a photocurable resin composition, in which compounding ratios of respective components are adjusted in specified ranges, particularly a content of a photopolymerizable initiator is adjusted in a specified range, solves the aforementioned problem, thereby leading to accomplishment of the present invention.

Specifically, the present invention provides the following [1] to [15].

[1] A photocurable resin composition including (A) a compound having a (meth)acryloyl group, (B) a photopolymerization initiator, and (C) a plasticizer, a content of the photopolymerization initiator (B) being 4.0 to 10% by mass.
[2] The photocurable resin composition as set forth above in [1], wherein an isoprene polymer having a (meth)acryloyl group is contained as the compound (A) having a (meth)acryloyl group.
[3] The photocurable resin composition as set forth above in [1] or [2], wherein a content of the compound (A) having a (meth)acryloyl group is 10 to 90% by mass relative to a total amount of the photocurable resin composition.
[4] The photocurable resin composition as set forth above in any one of [1] to [3], wherein (A1) a polymer having a (meth)acryloyl group in a molecule thereof and (A2) a monomer having one (meth)acryloyl group in a molecule thereof are contained as the compound (A) having a (meth)acryloyl group.
[5] The photocurable resin composition as set forth above in [4], wherein the monomer (A2) having one (meth)acryloyl group in a molecule thereof contains at least one (meth)acrylate having a dicyclopentanyl group, a dicyclopentenyl group, or an isobornyl group, and a content of the monomer (A2) having one (meth)acryloyl group in a molecule thereof is 10 to 40% by mass relative to a total amount of the photocurable resin composition.
[6] The photocurable resin composition as set forth above in any one of [1] to [5], further including (D) an antioxidant.
[7] The photocurable resin composition as set forth above in [6], wherein the antioxidant (D) contains (D1) a compound having a hindered phenol structure and (D2) a compound having a thioether structure.
[8] The photocurable resin composition as set forth above in any one of [1] to [7], which has a viscosity at 25° C. of 5.0×10² mPa·s to 5.0×10⁴ mPa·s.
[9] A method for manufacturing an image display device including an image display member and a light-transmitting cover member having a light-shielding layer formed on the periphery thereof, the image display member and the light-transmitting cover member being laminated via a light-transmitting cured resin layer formed of the photocurable resin composition as set forth above in any one of [1] to [8] such that a light-shielding layer forming surface of the light-transmitting cover member is disposed on the side of the image display member, the method including the following steps (I) to (III), and in the step (II), the photocurable resin composition being cured upon irradiation with an active energy ray such that a curing rate of the light-transmitting cured resin layer is 80% or more,

Step (I): a step of subjecting the photocurable resin composition to layer formation on a surface of the light-transmitting cover member on the light-shielding layer forming side thereof, or a surface of the image display member on the light-shielding layer side thereof, to form a photocurable resin composition layer,

Step (II): a step of curing the formed photocurable resin composition layer upon irradiation with an active energy ray to form a light-transmitting cured resin layer, and

Step (III): a step of sticking the image display member and the light-transmitting cover member to each other so as to interpose the light-shielding layer and the light-transmitting cured resin layer between the image display member and the light-transmitting cover member.

[10] The method for manufacturing an image display device as set forth above in [9], wherein in the step (I), the photocurable resin composition layer is formed on a surface of the light-transmitting cover member on the light-shielding layer forming side thereof.
[11] The method for manufacturing an image display device as set forth above in [9], wherein in the step (I), the photocurable resin composition layer is formed on a surface of the image display member.
[12] The method for manufacturing an image display device as set forth above in [11], wherein in the step (III), the image display member having a light-transmitting cured resin layer formed thereon and the light-transmitting cover member having a light-shielding layer formed thereon are embedded in gaps formed between the image display member and the light-shielding layer and between the image display member and the light-transmitting cover member.
[13] The method for manufacturing an image display device as set forth above in any one of [9] to [12], wherein in the step (I), the photocurable resin composition layer is formed in a thickness of 6 μm to 1.5×10³ μm on a surface of the image display member or the light-transmitting cover member.
[14] The method for manufacturing an image display device as set forth above in any one of [9] to [13], wherein the image display member is a liquid crystal display panel, an organic EL display panel, a plasma display panel, a touch panel, or a parallax barrier panel.
[15] An image display device including a cured product of the photocurable resin composition as set forth above in any one of [1] to [8].

### Advantageous Effects of Invention

According to the present invention, it is possible to provide a photocurable resin composition which is suitable for filling a space between a light-transmitting cover member, such as a protective panel, etc., and an image display member, etc. in an image display device, is able to inhibit liquid floating after photocuring by means of irradiation with an active energy ray in a pre-step of sticking the light-transmitting cover member and the image display member to each other, exhibits a sufficient adhesive force, and is able to contemplate to simplify a manufacturing step, an image displayer device using the same, and a method for manufacturing an image display device.

### BRIEF DESCRIPTION OF DRAWINGS

FIG. 1 is a view explaining an example of a step (I) of a method for manufacturing an image display device according to the present invention.

FIG. 2 is a view explaining an example of a step (I) of a method for manufacturing an image display device according to the present invention.

FIG. 3 is a view explaining an example of a step (II) of a method for manufacturing an image display device according to the present invention.

FIG. 4 is a view explaining an example of a step (III) of a method for manufacturing an image display device according to the present invention.

FIG. 5 is a view explaining an example of a step (I) of a method for manufacturing an image display device according to the present invention.

FIG. 6 is a view explaining an example of a step (II) of a method for manufacturing an image display device according to the present invention.

FIG. 7 is a view explaining an example of a step (III) of a method for manufacturing an image display device according to the present invention.

FIG. 8 is an explanatory view of an adhesive force test of a light-transmitting cured resin layer.

FIG. 9 is an explanatory view of a liquid floating test of a photocurable resin composition.

### DESCRIPTION OF EMBODIMENTS

The photocurable resin composition, the image display device using the same, and the method for manufacturing an image display device according to the present invention are hereunder described in more detail by reference to embodiments. It is to be noted that the present invention is not limited by these embodiments.

It is to be noted that in the drawings, the same or equivalent elements are designated by the same symbols, and their redundant description is omitted.

In addition, a “(meth)acrylate” as referred to in the present specification means an “acrylate” and a “methacrylate” corresponding thereto. Similarly, a “(meth)acryl” as referred to herein means an “acryl” and a “methacryl” corresponding thereto, and a “(meth)acryloyl” as referred to herein means an “acryloyl” and a “methacryloyl” corresponding thereto.

In addition, in the present specification, a molecular weight is a value obtained through measurement by means of gel permeation chromatography (GPC) and calculation using a calibration curve of standard polystyrene, and specifically, it means a value measured by the following method.

### <Molecular Weight Measurement>

A number average molecular weight (Mn) is measured based on the following method.

### Preparation Method of Calibration Curve:

The molecular weight is determined by adopting gel permeation chromatography (GPC) with tetrahydrofuran (hereinafter also referred to as “THF”) as a solvent and preparing a calibration curve using polystyrene as a standard material. In preparing the calibration curve, a five-sample set (PStQuick MP-H, PStQuick B [a trade name, manufactured by Tosoh Corporation]) is used as the standard polystyrene.
Device: High performance GPC apparatus, HCL-8320GPC (detector: differential refractometer or UV) (a trade name, manufactured by Tosoh Corporation)
Solvent used: THF
Column: Column TSKGEL SuperMultipore HZ-H (a trade name, manufactured by Tosoh Corporation)
Column size: Column length is 15 cm, and column inner diameter is 4.6 mm.
Measurement temperature: 40° C.
Flow rate: 0.35 mL/min
Sample concentration: 10 mg/5 mL of THF
Injection amount: 20 μL

In addition, a number average molecular weight, a weight average molecular weight, and a degree of dispersion are defined in the following manners.

(a) Number average molecular weight (Mn):

Mn=Σ(NᵢMᵢ)/ΣNᵢ=ΣXᵢMᵢ

(Xᵢ=(Molar fraction of molecule having a molecular weight Mᵢ)=Nᵢ/ΣNᵢ)

(b) Weight average molecular weight (Mw):

Mw=Σ(NᵢMᵢ²)/ΣNᵢMᵢ=ΣWᵢMᵢ

(Wᵢ=(Weight fraction of molecule having a molecular weight Mᵢ)=NᵢMᵢ/ΣNᵢMᵢ)

(c) Molecular weight distribution (degree of dispersion):

Degree of dispersion=Mw/Mn

### [Photocurable Resin Composition]

The photocurable resin composition according to the present invention (hereinafter also referred to simply as “resin composition”) contains (A) a compound having a (meth)acryloyl group (hereinafter also referred to as “component (A)”), (B) a photopolymerization initiator (hereinafter also referred to as “component (B)”), and (C) a plasticizer (hereinafter also referred to as “component (C)”), a content of the photopolymerization initiator (B) being 4.0 to 10% by mass.

### <Component (A): Compound Having a (Meth)Acryloyl Group>

The resin composition according to the present invention contains a compound having a (met)acryloyl group as the component (A). Examples of the compound having a (meth)acryloyl group include (A1) a polymer having a (meth)acryloyl group in a molecule thereof (hereinafter also referred to as “component (A1))” and (A2) a monomer having one (meth)acryloyl group in a molecule thereof (hereinafter also referred to as “component (A2)”). From the viewpoint of adjusting a viscosity of the resin composition and also from the viewpoints of reducing a curing shrinkage ratio and increasing pressure-sensitive adhesiveness to improve adhesive properties, it is preferred to use the component (A1) and the component (A2) in combination. In comparison with the case of using only the component (A1), by using the component (A2) in combination, pressure-sensitive adhesiveness can be more improved. In comparison with the case of using only the component (A2), by using the component (A1) in combination, the curing shrinkage ratio of the resin composition can be reduced, and delamination on the interface with an adherend can be inhibited.

Although other component than the component (A1) and the component (A2) may be used in combination as the component (A), it is preferred to use only the component (A1) and the component (A2).

The component (A1) and the component (A2) are hereunder described.

### (Component (A1): Polymer Having a (Meth)Acryloyl Group in a Molecule Thereof)

Examples of the polymer having a (meth)acryloyl group in a molecule thereof that is the component (A1) include a polyester oligomer having a (meth)acryloyl group, a urethane polymer having a (meth)acryloyl group, polyethylene glycol mono(meth)acrylate, polyethylene glycol di(meth)acrylate, polypropylene glycol mono(meth)acrylate, polypropylene glycol di(meth)acrylate, a butadiene polymer having a (meth)acryloyl group, an isoprene polymer having a (meth)acryloyl group, and the like.

Among these, from the viewpoints of transparency, yellowing resistance, and a balance among various properties, an isoprene polymer having a (meth)acryloyl group is preferred.

As the isoprene polymer having a (meth)acryloyl group, for example, a compound represented by the following general formula (1) is preferred.

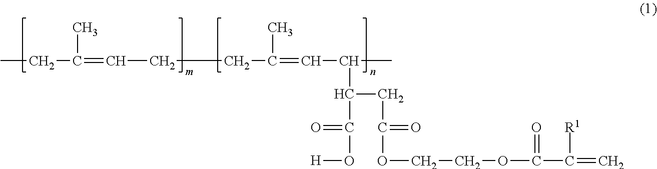

In the foregoing general formula (1), m represents a number of 50 to 1,000, n represents a number of 1 to 5, and R¹ represents a hydrogen atom or a methyl group.

m is a number of 50 to 1,000, preferably a number of 100 to 800, more preferably a number of 150 to 700, and still more preferably a number of 200 to 600.

n is a number of 1 to 5, preferably a number of 1.5 to 4.0, more preferably a number of 2.0 to 3.5, and still more preferably a number of 2.0 to 3.0.

Examples of a commercially available product of the compound represented by the foregoing general formula (1) include UC-102 and UC-203 (both of which are a trade name, manufactured by Kuraray Co., Ltd.) that are an esterification product between a maleic anhydride adduct of a polyisoprene polymer and 2-hydroxyethyl methacrylate; and the like.

An average functional group number in the component (A1) is preferably 1.5 to 4.0, more preferably 2.0 to 3.5, and still more preferably 2.0 to 3.0 from the viewpoint that the curing shrinkage ratio of the resin composition and elastic modulus can be more reduced.

The “functional group number” expresses a number of functional groups ((meth)acryloyl groups) in one molecule of the component (A1), and the “average functional group number” expresses an average value of functional group number per molecule in the whole of the component (A1).

A number average molecular weight (Mn) of the component (A1) is preferably 1.0×10⁴ or more, more preferably 1.25×10⁴ or more, and still more preferably 1.5×10⁴ or more, and preferably 1.0×10⁵ or less, more preferably 5.0×10⁴ or less, still more preferably 4.0×10⁴ or less, especially preferably 3.5×10⁴ or less, and extremely preferably 2.0×10⁴ or less, from the viewpoints of viscosity after compounding, workability, toughness of the cured product, and elastic modulus.

From the viewpoint of curing properties and moist heat resistance reliability, a content of the component (A1) in the resin composition is preferably 5% by mass or more relative to a total amount of the resin composition, and when further taking into consideration the adhesive force, the content of the component (A1) is more preferably 10% by mass or more, and still more preferably 15% by mass or more. From the viewpoints of curing shrinkage ratio and elastic modulus, the content of the component (A1) is preferably 55% by mass or less, and when further taking into consideration the adhesive force, the content of the component (A1) is more preferably 40% by mass or less, and still more preferably 25% by mass or less.

When the content of the component (A1) is 5% by mass or more, not only the curing properties of the resin composition may be improved, but also the moist heat resistance reliability of the cured product may be made favorable. On the other hand, when the content of the component (A1) is 55% by mass or less, not only the curing shrinkage ratio becomes favorable, but also the elastic modulus of the cured product does not become excessively large, and hence, such is preferred.

### (Component (A2): Monomer Having One (Meth)Acryloyl Group in a Molecule Thereof)

The monomer having one (meth)acryloyl group in a molecule thereof that is the component (A2) is preferably liquid at ordinary temperature (25° C.).

The component (A2) is preferably a compound having a dicyclopentanyl group, a dicyclopentenyl group, or an isobornyl group in a molecule thereof, more preferably a compound having a dicyclopentenyl group or an isobornyl group in a molecule thereof, and still more preferably a compound having a dicyclopentenyl group in a molecule thereof. These plural kinds of compounds may be used alone or in combination.

A (meth)acrylate represented by the following general formula (2) is preferably exemplified as the component (A2).

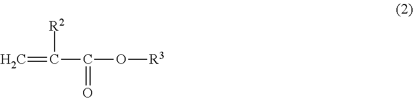

In the foregoing general formula (2), R² represents a hydrogen atom or a methyl group, and R³ represents an alkyl group having 4 to 20 carbon atoms. From the viewpoint of more giving flexibility, R³ is preferably an alkyl group having 6 to 18 carbon atoms, more preferably an alkyl group having 8 to 16 carbon atoms, and still more preferably an alkyl group having 8 to 12 carbon atoms.

Examples of the component (A2) include alkyl (meth)acrylates, such as n-butyl (meth)acrylate, tert-butyl (meth)acrylate, isobutyl (meth)acrylate, n-pentyl (meth)acrylate, n-octyl (meth)acrylate, isooctyl (meth)acrylate, 2-ethylhexyl (meth)acrylate, isodecyl (meth)acrylate, n-hexyl (meth)acrylate, stearyl (meth)acrylate, lauryl (meth)acrylate, tridecyl (meth)acrylate, etc.; hydroxyl group-containing (meth)acrylates, such as 2-hydroxyethyl (meth)acrylate, 1-hydroxyethyl (meth)acrylate, 2-hydroxypropyl (meth)acrylate, 3-hydroxypropyl (meth)acrylate, 1-hydroxypropyl (meth)acrylate, 4-hydroxybutyl (meth)acrylate, 3-hydroxybutyl (meth)acrylate, 2-hydroxybutyl (meth)acrylate, 1-hydroxybutyl (meth)acrylate, etc.; (meth)acrylamides, such as dimethyl (meth)acrylamide, isopropyl (meth)acrylamide, dimethylaminopropyl (meth)acrylamide, etc.; hydroxyl group-containing (meth)acrylamides, such as hydroxyethyl (meth)acrylamide, etc.; polyethylene glycol mono(meth)acrylates, such as diethylene glycol, triethylene glycol, etc.; polypropylene glycol mono(meth)acrylates, such as dipropylene glycol, tripropylene glycol, etc.; polybutylene glycol mono(meth)acrylates, such as dibutylene glycol, tributylene glycol, etc.; morpholine group-containing (meth)acrylates, such as acryloyl morpholine, etc.; dicyclopentanyl (meth)acrylate, dicyclopentenyloxy (meth)acrylate, dicyclopentenyloxyethyl (meth)acrylate, isobornyl (meth)acrylate, and the like.

These compounds may be used alone or in combination of two or more thereof.

Among these, from the viewpoints of optical properties, liquid floating, adhesive force, moist heat resistance reliability, and pressure-sensitive adhesiveness after curing, it is preferred to contain at least one (meth)acrylate having a dicyclopentanyl group, a dicyclopentenyl group, or an isobornyl group; it is more preferred to contain at least one (meth)acrylate having a dicyclopentenyl group or an isobornyl group; and it is still more preferred to contain a (meth)acrylate having a dicyclopentenyl group. These plural kinds of compounds may be used alone or in combination.

From the viewpoint of obtaining a resin composition having an appropriate viscosity, from the viewpoint of adjusting the curing shrinkage ratio, and also from the viewpoint of improving the transparency of a cured product, a content of the component (A2) in the resin composition is preferably 10% by mass or more, more preferably 15% by mass or more, and still more preferably 20% by mass or more relative to a total amount of the resin composition; and from the viewpoint of adjusting the curing shrinkage ratio and the elastic modulus of a cured product, the content of the component (A2) is preferably 40% by mass or less, more preferably 35% by mass or less, and still more preferably 30% by mass or less relative to a total amount of the resin composition.

When the content of the component (A2) is 10% by mass or more, not only a resin composition having an appropriate viscosity may be provided and the workability of coating or the like may be made favorable, but also the curing shrinkage ratio may be reduced. In addition, the transparency of a cured product may be improved.

When the content of the component (A2) is 40% by mass or less, the matter that the curing shrinkage ratio and the elastic modulus become excessively high may be suppressed, and when used for an image display device, the generation of display unevenness and warp of a module may be inhibited.

A mass ratio (A1)/(A2) of the component (A1) and the component (A2) is preferably 0.1 or more, more preferably 0.2 or more, still more preferably 0.3 or more, especially preferably 0.4 or more, and extremely preferably 0.5 or more, and preferably 5.5 or less, more preferably 4.0 or less, still more preferably 3.0 or less, especially preferably 2.0 or less, and extremely preferably 1.0 or less.

A content of the component (A) is preferably 10% by mass or more, more preferably 20% by mass or more, still more preferably 30% by mass or more, and especially preferably 40% by mass or more, and preferably 90% by mass or less, more preferably 70% by mass or less, still more preferably 60% by mass or less, and especially preferably 50% by mass or less relative to a total amount of the resin composition.

### <Component (B): Photopolymerization Initiator>

The photopolymerization initiator as the component (B) is a kind of a polymerization initiator that emits a radical upon irradiation of an active energy ray, such as an ultraviolet ray, an electron beam, an α-ray, a β-ray, etc. and promotes a curing reaction of the resin composition.

Examples of the photopolymerization initiator (B) include aromatic ketone compounds, such as benzophenone, N,N′-tetramethyl-4,4′-diaminobenzophenone (Michler's ketone), N,N′-tetraethyl-4,4′-diaminobenzophenone, 4-methoxy-4,4′-dimethylaminobenzophenone, α-hydroxyisobutylphenone, 2-ethylanthraquinone, tert-butylanthraquinone, 1,4-dimethylanthraquinone, 1-chloroanthraquinone, 2,3-dichloroanthraquinone, 3-chloro-2-methylanthraquinone, 1,2-benzoanthraquinone, 2-phenylanthraquinone, 1,4-naphthoquinone, 9,10-phenanthraquinone, thioxanthone, 2-chlorothioxanthone, 2,2-dimethoxy-1,2-diphenylethan-1-one, 2,2-diethoxyacetophenone, etc.; benzoin compounds, such as benzoin, methyl benzoin, ethyl benzoin, etc.; benzoin ether compounds, such as benzoin methyl ether, benzoin ethyl ether, benzoin isobutyl ether, benzoin phenyl ether, etc.; benzil compounds, such as benzil, benzil dimethyl ketal, etc.; ester compounds, such as β-(acridin-9-yl) (meth)acrylate, etc.; acridine compounds, such as 9-phenylacridine, 9-pyridylacridine, 1,7-diacridinoheptane, etc.; 2,4,5-triarylimidazole dimers, such as a 2-(o-chlorophenyl)-4,5-diphenylimidazole dimer, a 2-(o-chlorophenyl)-4,5-di(m-methoxyphenyl)imidazole dimer, a 2-(o-fluorophenyl)-4,5-diphenylimidazole dimer, a 2-(o-methoxyphenyl)-4,5-diphenylimidazole dimer, a 2-(p-methoxyphenyl)-4,5-diphenylimidazole dimer, a 2,4-di(p-methoxyphenyl)-5-phenylimidazole dimer, a 2-(2,4-dimethoxyphenyl)-4,5-diphenylimidazole dimer, a 2-(p-methylmercaptophenyl)-4,5-diphenylimidazole dimer, etc.; alkylphenone-based compounds, such as 2-benzyl-2-dimethylamino-1-(4-morpholinophenyl)-1-butanone, 2-methyl-1-[4-(methylthio)phenyl]-2-morpholino-1-propanone, etc.; α-hydroxyalkylphenone-based compounds, such as 1-hydroxycyclohexyl phenyl ketone, 2-hydroxy-2-methyl-1-phenyl-propan-1-one, 1-[4-(2-hydroxyethoxy)-phenyl]-2-hydroxy-2-methyl-1-propan-1-one, 2-hydroxy-1-{4-[4-(2-hydroxy-2-methyl-propionyl)-benzyl]phenyl}-2-methyl-propan-1-one, oligo(2-hydroxy-2-methyl-1-(4-(1-methylvinyl)phenyl)propanone), etc.; phenylglyoxylic acid methyl ester; phosphine oxide-based compounds, such as bis(2,4,6-trimethylbenzoyl)-phenylphosphine oxide, bis(2,6-dimethoxybenzoyl)-2,4,4-trimethyl-pentylphosphine oxide, 2,4,6-trimethylbenzoyl-diphenylphosphine oxide, etc.; and the like. Among these, in particular, from the viewpoints of curing properties and reactivity, aromatic ketone compounds, phenylglyoxylic acid methyl ester, phosphine oxide-based compounds, and α-hydroxyalkylphenone-based compounds are preferred, α-hydroxyalkylphenone-based compounds and phosphine oxide-based compounds are more preferred, and phosphine oxide-based compounds are still more preferred.

These compounds may be used alone or in combination of two or more thereof.

In the present invention, a content of the component (B) is 4.0% by mass or more and 10% by mass or less relative to a total amount of the resin composition. From the viewpoint of promoting a curing reaction, the content of the component (B) is preferably 4.5% by mass or more, more preferably 5.0% by mass or more, still more preferably 5.2% by mass or more, especially preferably 5.4% by mass or more, and extremely preferably 5.5% by mass or more; and from the viewpoint of pressure-sensitive adhesiveness, the content of the component (B) is preferably 9.0% by mass or less, more preferably 8.0% by mass or less, still more preferably 7.5% by mass or less, especially preferably 7.0% by mass or less, and extremely preferably 6.5% by mass or less.

When the content of the component (B) is less than 4.0% by mass, the curing reaction cannot be promoted on the film surface in the presence of oxygen, so that a cured product cannot be provided. On the other hand, when the content of the component (B) is more than 10% by mass, the pressure-sensitive adhesiveness is decreased.

In the case of using a phosphine oxide-based compound as the component (B), from the viewpoint of promoting a curing reaction, a content of the phosphine oxide-based compound is preferably 4.5% by mass or more, more preferably 5.0% by mass or more, still more preferably 5.2% by mass or more, especially preferably 5.4% by mass or more, and extremely preferably 5.6% by mass or more relative to a total amount of the resin composition; and from the viewpoint of pressure-sensitive adhesiveness, the content is preferably 9.0% by mass or less, more preferably 8.0% by mass or less, still more preferably 7.5% by mass or less, especially preferably 7.0% by mass or less, and extremely preferably 6.5% by mass or less.

A mass ratio (B)/(A) of the component (A) and the component (B) is preferably 0.05 or more, more preferably 0.07 or more, still more preferably 0.08 or more, yet still more preferably 0.09 or more, especially preferably 0.1 or more, and extremely preferably 0.12 or more, and preferably 0.9 or less, more preferably 0.5 or less, still more preferably 0.3 or less, yet still more preferably 0.25 or less, especially preferably 0.2 or less, and extremely preferably 0.14 or less.

### <Component (C): Plasticizer>

The plasticizer which is used as the component (C) in the present invention does not substantially have a (meth)acryloyl group. From the viewpoints of workability at the time of fabrication of a photocurable resin composition and inhibition of deposition of the plasticizer to be caused due to recrystallization or the like, the component (C) is preferably liquid at 25° C.

Examples of the component (C) include liquid materials of butadiene rubber, isoprene rubber, silicon rubber, styrene butadiene rubber, chloroprene rubber, nitrile rubber, butyl rubber, ethylene propylene rubber, urethane rubber, acrylic rubber, chlorosulfonated polyethylene rubber, fluorine rubber, hydrogenated nitrile rubber, and epichlorohydrin rubber; poly-α-olefins, such as, polybutene, etc.; hydrogenated α-olefin oligomers, such as hydrogenated polybutene, etc.; polyvinyl-based oligomers, such as atactic polypropylene, etc.; aromatic oligomers, such as biphenyl, triphenyl, etc.; hydrogenated polyene-based oligomers, such as hydrogenated liquid polybutadiene, etc.; paraffin-based oligomers, such as paraffin oil, chlorinated paraffin oil, etc.; cycloparaffin-based oligomers, such as naphthene oil, etc.; phthalic acid derivatives, such as dimethyl phthalate, diethyl phthalate, dibutyl phthalate, di-(2-ethylhexyl) phthalate, di-n-octyl phthalate, diisobutyl phthalate, diheptyl phthalate, diphenyl phthalate, diisodecyl phthalate, ditridecyl phthalate, diundecyl phthalate, di(heptyl, nonyl, undecyl) phthalate, benzyl phthalate, butylbenzyl phthalate, dinonyl phthalate, dicyclohexyl phthalate, etc.; isophthalic acid derivatives, such as dimethyl isophthalate, di-(2-ethylhexyl) isophthalate, diisooctyl isophthalate, etc.; tetrahydrophthalic acid derivatives, such as di-(2-ethylhexyl)tetrahydrophthalate, di-n-octyl tetrahydrophthalate, diisodecyl tetrahydrophthalate, etc.; adipic acid derivatives, such as di-n-butyl adipate, di(2-ethylhexyl) adipate, diisodecyl adipate, diisononyl adipate, etc.; azelaic acid derivatives, such as di-(2-ethylhexyl) azelate, diisooctyl azelate, di-n-hexyl azelate, etc.; sebacic acid derivatives, such as di-n-butyl sebacate, di-(2-ethylhexyl) sebacate, etc.; maleic acid derivatives, such as di-n-butyl maleate, dimethyl maleate, diethyl maleate, di-(2-ethylehxyl) maleate, etc.; fumaric acid derivatives, such as di-n-butyl fumarate, di-(2-ethylhexyl) fumarate, etc.; trimellitic acid derivatives, such as tri-(2-ethylhexyl)trimellitate, tri-n-octyl trimellitate, triisodecyl trimellitate, triisooctyl trimellitate, tri-n-hexyl trimellitate, triisononyl trimellitate, etc.; pyromellitic acid derivatives, such as tetra-(2-ethylhexyl) pyromellitate, tetra-n-octyl pyromellitate, etc.; citric acid derivatives, such as triethyl citrate, tri-n-butyl citrate, acetyl triethyl citrate, acetyl tri-(2-ethylhexyl) citrate, etc.; itaconic acid derivatives, such as monomethyl itaconate, monobutyl itaconate, dimethyl itaconate, diethyl itaconate, dibutyl itaconate, di-(2-ethylhexyl) itaconate, etc.; oleic acid derivatives, such as butyl oleate, glyceryl monooleate, diethylene glycol monooleate, etc.; ricinolic acid derivatives, such as methyl acetyl ricinolate, butyl acetyl ricinolate, glyceryl monoricinolate, diethylene glycol monoricinolate, etc.; stearic acid derivatives, such as n-butyl stearate, glycerin monostearate, diethylene glycol distearate, etc.; other fatty acid derivatives, such as diethylene glycol monolaurate, diethylene glycol dipelargonate, a pentaerythritol fatty acid ester, etc.; phosphoric acid derivatives, such as triethyl phosphate, tributyl phosphate, tri-(2-ethylhexyl)phosphate, tributoxyethyl phosphate, triphenyl phosphate, cresyl diphenyl phosphate, tricresyl phosphate, trixylenyl phosphate, tris(chloroethyl)phosphate, etc.; glycol derivatives, such as diethylene glycol dibenzoate, dipropylene glycol dibenzoate, triethylene glycol dibenzoate, triethylene glycol di-(2-ethylbutyrate), triethylene glycol di-(2-ethylhexoate), dibutyl methylene bisthioglycolate, etc.; glycerin derivatives, such as glycerol monoacetate, glycerol triacetate, glycerol tributyrate, etc.; epoxy derivatives, such as epoxidized soy oil, diisodecyl epoxy hexahydrophthalate, epoxy triglyceride, epoxidized octyl oleate, epoxidized decyl oleate, etc.; and the like.

These compounds may be used alone or in combination of two or more thereof.

Among these, in the case of using an isoprene polymer having a (meth)acryloyl group as the component (A1), butadiene rubber, isoprene rubber, poly-α-olefins, hydrogenated α-olefin oligomers, and di-(2-ethylhexyl) sebacate are preferred, and butadiene rubber and butadiene rubber having a terminal hydroxyl group are more preferred, from the viewpoints of volatility, viscosity, workability, yellowing resistance, compatibility, and heat resistance.

A number average molecular weight of the component (C) is preferably 3.5×10² or more, more preferably 4.0×10² or more, still more preferably 5.0×10² or more, and especially preferably 8.0×10² or more from the viewpoints of optical properties and viscosity adjustment of the plasticizer and also from the viewpoint of viscosity adjustment of the resin composition; and the number average molecular weight is preferably 3.0×10⁴ or less, more preferably 1.0×10⁴ or less, still more preferably 5.0×10³ or less, and especially preferably 3.5×10³ or less from the viewpoints of volatility of the plasticizer and viscosity adjustment of the resin composition.

When the number average molecular weight of the component (C) is 3.5×10² or more, volatilization of the plasticizer may be inhibited. When the number average molecular weight of the component (C) is 3.0×10⁴ or less, an excessive increase of the viscosity of the plasticizer and cloudiness of the plasticizer may be inhibited.

From the viewpoint of adjusting an elastic force of a cured product within an appropriate range, a content of the component (C) is preferably 20% by mass or more, more preferably 30% by mass or more, still more preferably 35% by mass or more, and especially preferably 40% by mass or more, and preferably 80% by mass or less, more preferably 70% by mass or less, still more preferably 65% by mass or less, and especially preferably 60% by mass or less, relative to a total amount of the resin composition.

When the content of the component (C) is 20% by mass or more, the generation of warp, which may be caused due to an excessive increase of the elastic modulus, may be inhibited. When the content of the component (C) is 80% by mass or less, lowering in adhesive force and reliability, which may be caused due to an excessive decrease of the elastic modulus, may be inhibited.

### <Other Additives>

The resin composition according to the present invention may be further compounded with other additives within the range where the effects of the present invention are not hindered.

As other additives, general additives, such as an adhesion improver, such as a silane coupling agent, etc., a thermopolymerization initiator, a moisture curing agent, (D) an antioxidant (hereinafter also referred to as “component (D)”), a thixotropic agent, a chain transfer agent, a stabilizer, a photosensitizer, etc., may be contained.

### <Component (D): Antioxidant>

Among those, the antioxidant (D) is preferably used in the resin composition according to the present invention from the viewpoint that liquid floating and yellowing may be inhibited.

Examples of a preferred embodiment of the antioxidant (D) include (D1) compounds having a hindered phenol structure (hereinafter also referred to as “component (D1)”), amine-based compounds, phosphorus-based compounds, sulfur-based compounds, hydrazine-based compounds, amide-based compounds, and the like. Among these, compounds (D1) having a hindered phenol structure are more preferred from the viewpoint that bleedout may be inhibited. Among the compounds (D1) having a hindered phenol structure, (D1′) a hindered phenol-based compound having a thioether structure (hindered phenol-thioether-based compound) as described later, or a combination of a compound (D1) having a hindered phenol structure and a sulfur-based compound is still more preferably used from the viewpoint that the yellowing may be inhibited. As the sulfur-based compound to be used in combination, it is preferred to use (D2) a compound having a thioether structure as described later.

### [Component (D1): Compound Having a Hindered Phenol Structure]

As for the compound (D1) having a hindered phenol structure, it is preferred to use a compound represented by the following general formula (3), and from the viewpoint that the yellowing can be more inhibited, it is more preferred to use (D1′) a hindered phenol-based compound having a thioether structure (hindered phenol-thioether-based compound) as represented by the following general formula (4).

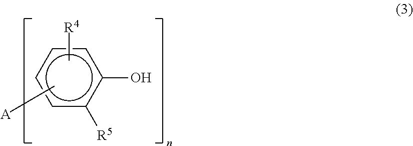

In the general formula (3), R⁵ represents a tert-butyl group or —CH₂—S—R^{a}, R⁴ represents an alkyl group having 1 to 5 carbon atoms or —CH₂—S—R^{a}, each of R⁴s independently represents a substituent, and a plurality thereof may be present, n represents an integer of 1 to 4, A represents an n-valent organic group, and R^{a} represents an alkyl group having 1 to 20 carbon atoms.

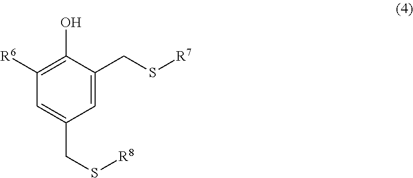

In the general formula (4), R⁶ represents an alkyl group having 1 to 5 carbon atoms, and each of R⁷ and R⁸ independently represents an alkyl group having 1 to 20 carbon atoms.

Examples of the compound (D1) having a hindered phenol structure include pentaerythritol tetrakis[3-(3,5-di-tert-butyl-hydroxyphenyl)propionate] (a trade name: IRGANOX 1010, manufactured by BASF Japan Ltd.), thiodiethylene bis[3-(3,5-di-tert-butyl-4-hydroxyphenyl)propionate] (a trade name: IRGANOX 1035, manufactured by BASF Japan Ltd.), octadecyl-3-(3,5-di-tert-butyl-4-hydroxyphenyl)propionate (a trade name: IRGANOX 1076, manufactured by BASF Japan Ltd.), N,N′-hexane-1,6-diyl bis[3-(3,5-di-tert-butyl-4-hydroxyphenyl)propionamide] (a trade name: IRGANOX 1098, manufactured by BASF Japan Ltd.), benzenepropanoic acid, 3,5-bis(1,1-dimethylethyl)-4-hydroxy, C7-C9 side chain alkyl ester (a trade name: IRGANOX 1135, manufactured by BASF Japan Ltd.), 2,4-dimethyl-6-(1-methylpentadecyl)phenol (a trade name: IRGANOX 1141, manufactured by BASF Japan Ltd.), diethyl [{3,5-bis(1,1-dimethylethyl)-4-hydroxyphenyl}methyl]phosphonate (a trade name: IRGANOX 1222, manufactured by BASF Japan Ltd.), 3,3′,3″,5,5′,5″-hexa-tert-butyl-a,a′,a″-(mesitylene-2,4,6-triyl)tri-p-cresol (a trade name: IRGANOX 1330, manufactured by BASF Japan Ltd.), a mixture of calcium diethyl bis[[[3,5-bis(1,1-dimethylethyl)-4-hydroxyphenyl]methyl]phosphonate] and polyethylene wax (a trade name: IRGANOX 1425WL, manufactured by BASF Japan Ltd.), 4,6-bis(octylthiomethyl)-o-cresol (a trade name: IRGANOX 1520L, manufactured by BASF Japan Ltd.), ethylene bis(oxyethylene)bis[3-(tert-butyl-4-hydroxy-m-tolyl)propionate] (a trade name: IRGANOX 245, manufactured by BASF Japan Ltd.), 1,6-hexanediol-bis[3-(3,5-di-tert-butyl-4-hydroxyphenyl)propionate] (a trade name: IRGANOX 259, manufactured by BASF Japan Ltd.), 1,3,5-tris(3,5-di-tert-butyl-4-hydroxybenzyl)isocyanuric acid (a trade name: IRGANOX 3114, manufactured by BASF Japan Ltd.), 1,3,5-tris[(4-tert-butyl-3-hydroxy-2,6-xylyl)methyl]-1,3,5-triazine-2,4,6-(1H,3H,5H)-trione (a trade name: IRGANOX 3790, manufactured by BASF Japan Ltd.), a reaction product between N-phenylbenzeneamine and 2,4,4-trimethylpentene (a trade name: IRGANOX 5057, manufactured by BASF Japan Ltd.), 6-(4-hydroxy-3,5-di-tert-butylanilino)-2,4-bisoctylthio-1,3,5-triazine (a trade name: IRGANOX 565, manufactured by BASF Japan Ltd.), 1,3,5-tris(3,5-di-tert-butyl-4-hydroxybenzyl)isocyanuric acid (a trade name: ADEKA STAB AO-20, manufactured by Adeka Corporation), 1,1,3-tris(2-methyl-4-hydroxy-5-tert-butylphenyl)butane (a trade name: ADEKA STAB AO-30, manufactured by Adeka Corporation), 4,4′-butylidene bis(6-tert-butyl-3-methylphenol) (a trade name: ADEKA STAB AO-40, manufactured by Adeka Corporation), n-octadecyl 3-(4′-hydroxy-3′,5′-di-tert-butylphenyl)propionate (a trade name: ADEKA STAB AO-50, manufactured by Adeka Corporation), pentaerythritol tetrakis[3-(3′,5′-di-tert-butyl-4′-hydroxyphenyl)propionate] (a trade name: ADEKA STAB AO-60, manufactured by Adeka Corporation), triethylene glycol bis[3-(3-tert-butyl-4-hydroxy-5-methylphenyl)propionate] (a trade name: ADEKA STAB AO-70, manufactured by Adeka Corporation), 3,9-bis[1,1-dimethyl-2-[β-(3-tert-butyl-4-hydroxy-5-methylphenylpropionyloxy]ethyl]-2,4,8,10-tetraoxaspiro[5,5]-undecane (a trade name: ADEKA STAB AO-80, manufactured by Adeka Corporation), 1,3,5-trimethyl-2,4,6-tris(3,5-di-tert-butyl-4-hydroxybenzyl)benzene (a trade name: ADEKA STAB AO-330, manufactured by Adeka Corporation), 2,2-oxamidobis-[ethyl-3-(3,5-di-tert-butyl-4-hydroxyphenyl)propionate] (a trade name: NAUGARD XL-1, manufactured by Chemtura Corporation), 1,1,3-tris{2-methyl-4-[3-(3,5-di-tert-butyl-4-hydroxyphenyl)propionyloxy]-5-tert-butylphenyl}butane (a trade name: GSY-242, manufactured by API Corporation), and the like. Among these, from the viewpoint that the bleedout may be inhibited, pentaerythritol tetrakis[3-(3,5-di-tert-butyl-4-hydroxyphenyl)propionate] and 4,6-bis(octylthiomethyl)-o-cresol are preferred, and from the viewpoint that both the bleedout and the yellowing may be inhibited and also from the viewpoint of easy handling, 4,6-bis(octylthiomethyl)-o-cresol having a thioether structure in a molecule thereof is especially preferred. In the case of use over a wide range, or the like, from the viewpoints that the bleedout may be inhibited, an offensive smell is low, and the operability is excellent, benzenepropanoic acid, 3,5-bis(1,1-dimethylethyl)-4-hydroxy, C7-C9 side chain alkyl ester that is liquid is more preferred.

### [Component (D2): Compound Having a Thioether Structure]

As the compound (D2) having a thioether structure, it is preferred to use a compound represented by the following general formula (5).

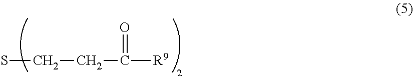

In the general formula (5), R⁹ represents an alkyl group having 1 to 20 carbon atoms.

Examples of the compound (D2) having a thioether structure include didodecyl thiodipropionate (a trade name: SEENOX DL, manufactured by Shipro Kasei Kaisha, Ltd.; a trade name: IRGANOX PS 800 FL, manufactured by BASF Japan Ltd.; and a trade name: SUMILIZER TPL-R, manufactured by Sumitomo Chemical Co., Ltd.), ditridecyl-3,3′-thiodipropionate (a trade name: AO-503, manufactured by Adeka Corporation), ditetradecyl thiodipropionate (a trade name: SUMILIZER TPM, manufactured by Sumitomo Chemical Co., Ltd.), and distearyl thiodipropionate (a trade name: SUMILIZER TPD, manufactured by Sumitomo Chemical Co., Ltd.).

From the viewpoint that the bleedout can be more inhibited, a content of the component (D) is preferably 0.5% by mass or more, more preferably 0.6% by mass or more, and still more preferably 0.7% by mass or more, and preferably 3.0% by mass or less, more preferably 2.7% by mass or less, and still more preferably 2.5% by mass or less, relative to a total amount of the resin composition.

When the content of the component (D) is 0.5% by mass or more, yellowing and bleedout of the resin composition may be inhibited. When the content of the component (D) is 3.0% by mass or less, lowering in curability and sensitivity may be inhibited.

In the case of using the component (D1) and the component (D2) in combination, a mass ratio (D1)/(D2) of the component (D1) and the component (D2) is preferably 0.25 or more, more preferably 0.3 or more, and still more preferably 0.5 or more, and preferably 4 or less, more preferably 3 or less, and still more preferably 2 or less.

### (Chain Transfer Agent and Stabilizer)

For the purpose of adjusting the molecular weight, the resin composition according to the present invention may contain a chain transfer agent.

Examples of the chain transfer agent include thiol compounds, such as 2-mercaptoethanol, lauryl mercaptan, glycidyl mercaptan, mercaptoacetic acid, 2-ethylhexyl thioglycolate, 2,3-dimercapto-1-propanol, α-methylstyrene dimer, 1,4-bis(3-mercaptobutyryloxy)butane, 1,3,5-tris(3-mercaptobutyloxyethyl)-1,3,5-triazine-2,4,6(1H,3H,5H)-trione, pentaerythritol tetrakis(3-mercaptobutyrate), etc.; and the like.

For the purpose of preventing inhibition due to oxygen at the time of photocuring, the resin composition according to the present invention may contain a stabilizer, such as triphenyl phosphite, etc.

### (Organic Solvent)

From the viewpoints of moist heat resistance reliability and inhibition of the generation of air bubbles in a cured product, it is preferred that the resin composition according to the present invention does not substantially contain an organic solvent.

In the present invention, the “organic solvent” means an organic compound that does not have a (meth)acryloyl group, is liquid at 25° C., and has a boiling point of 250° C. or lower at atmospheric pressure.

Here, it is meant by the terms “does not substantially contain an organic solvent” that an organic solvent is not intentionally added. So long as the properties of the resin composition according to the present invention after photocuring are not remarkably lowered, a trance amount of an organic solvent may be present.

Specifically, a content of the organic solvent in the resin composition is preferably 1.0×10³ ppm or less, more preferably 5.0×10² ppm or less, and still more preferably 1.0×10² ppm or less relative to a total amount of the resin composition. It is especially preferred that the resin composition does not contain an organic solvent at all.

### <Viscosity of Photocurable Resin Composition>

From the viewpoint of workability, a viscosity at 25° C. of the resin composition according to the present invention is preferably 10 mPa·s or more, more preferably 4.0×10² mPa·s or more, still more preferably 5.0×10² mPa·s or more, yet still more preferably 1.0×10³ mPa·s or more, especially preferably 2.0×10³ mPa·s or more, and extremely preferably 3.0×10³ mPa·s or more, and preferably 5.0×10⁴ mPa·s or less, more preferably 2.0×10⁴ mPa·s or less, still more preferably 1.5×10⁴ mPa·s or less, yet still more preferably 1.25×10⁴ mPa·s or less, and especially preferably 1.0×10⁴ mPa·s or less.

The viscosity at 25° C. as referred to herein is a value as measured in conformity with JIS Z8803, and specifically, the viscosity may be measured by a B-type viscometer (a trade name: BL2, manufactured by Toki Sangyo Co., Ltd.). The calibration of the viscometer may be performed in conformity with JIS Z8809-JS14000.

### <Curing Shrinkage Ratio of Photocurable Resin Composition>

In the case of using the resin composition according to the present invention as a constituent member of an image display device, from the viewpoint of more highly inhibiting a warp of a substrate of a protective panel, an image display unit, or the like, a curing shrinkage ratio of the resin composition is preferably less than 4.0%, more preferably less than 3.5%, and still more preferably less than 3.0%. When the curing shrinkage ratio is less than 4.0%, the warp of the substrate may be sufficiently inhibited.

The curing shrinkage ratio as referred to herein may be calculated according to the following calculation formula.

Curing shrinkage ratio (%)=[{1/(Specific gravity of liquid)}−{1/(Specific gravity of cured product)}]/{1/(Specific gravity of liquid)}

The specific gravity of liquid and the specific gravity of cure product in the foregoing formula may be measured by the following methods.

### (Measurement Method of Specific Gravity of Liquid)

The measurement is performed using a Hubbard type specific gravity bottle in conformity with JIS K0061.

### (Measurement Method of Specific Gravity of Cured Product)

The resin composition is dropped on a polyethylene terephthalate (hereinafter also referred to as “PET”) film, a surface of which has been subjected to a releasing treatment, and another sheet of PET film is stuck thereto such that a film thickness after curing the resin composition is 1 mm. The resin composition is cured upon irradiation with an ultraviolet ray at a dose of 1.0×10⁴ mJ/cm² by using an ultraviolet ray irradiation apparatus from the side of the one-sided PET film, thereby fabricating a cured product.

Subsequently, the PET films are peeled, and the resulting cured product is subjected to cutting to prepare a test piece having a size of 10 mm×10 mm. The test piece is measured at 25° C. for a specific gravity by using a densimeter (a trade name: SD-200L, manufactured by Alfa Mirage Co., Ltd.), and the measured value can be defined as a specific gravity of the cured product.

### <Elastic Modulus of Cured Product of Photocurable Resin Composition>

In the case of using a cured product of the resin composition according to the present invention as a constituent member of an image display device, from the viewpoints of inhibiting local stress addition to an image display unit or the like and suppressing the generation of display unevenness, an elastic modulus of the cured product of the resin composition is preferably 2.0×10⁵ Pa or less, more preferably 1.5×10⁵ Pa or less, and still more preferably 1.0×10⁵ Pa or less. When the elastic modulus is 2.0×10⁵ Pa or less, it is possible to inhibit the local stress addition to an image display unit, which may be possibly a cause of the generation of display unevenness.

With respect to the cured product of the resin composition according to the present invention, so long as when heated, a liquid material is not separated nor dripped from the cured product, a lower limit of its elastic modulus is not limited; however, it is preferably 1.0×10⁴ Pa or more.

In the present invention, the elastic modulus of the cured product of the resin composition means a value of tensile elastic modulus obtained by measuring a cured product having a film thickness t of 1 mm and a width of 10 mm at a chuck-to-chuck distance of 25 mm by using an autograph (a trade name: EZ Test, manufactured by Shimadzu Corporation).

### [Method for Manufacturing Image Display Device]

Next, a method for manufacturing an image display device capable of being manufactured by using the resin composition according to the present invention is described. The method for manufacturing an image display device according to the present invention is concerned with a method for manufacturing an image display device including an image display member and a light-transmitting cover member having a light-shielding layer formed on the periphery thereof, the image display member and the light-transmitting cover member being laminated via a light-transmitting cured resin layer formed of the photocurable resin composition according to the present invention such that a light-shielding layer forming surface of the light-transmitting cover member is disposed on the side of the image display member, the method including the following steps (I) to (III), and in the step (II), the photocurable resin composition being irradiated with an active energy ray and cured such that a curing rate of the light-transmitting cured resin layer is 80% or more,

Step (I): a step of subjecting the photocurable resin composition to layer formation on a surface of the light-transmitting cover member on the light-shielding layer forming side thereof, or a surface of the image display member on the light-shielding layer side thereof, to form a photocurable resin composition layer,

Step (II): a step of curing the formed photocurable resin composition layer upon irradiation with an active energy ray to form a light-transmitting cured resin layer, and

Step (III): a step of sticking the image display member and the light-transmitting cover member to each other so as to interpose the light-shielding layer and the light-transmitting cured resin layer between the image display member and the light-transmitting cover member.

### <Step (I): Forming Step of Photocurable Resin Composition Layer>

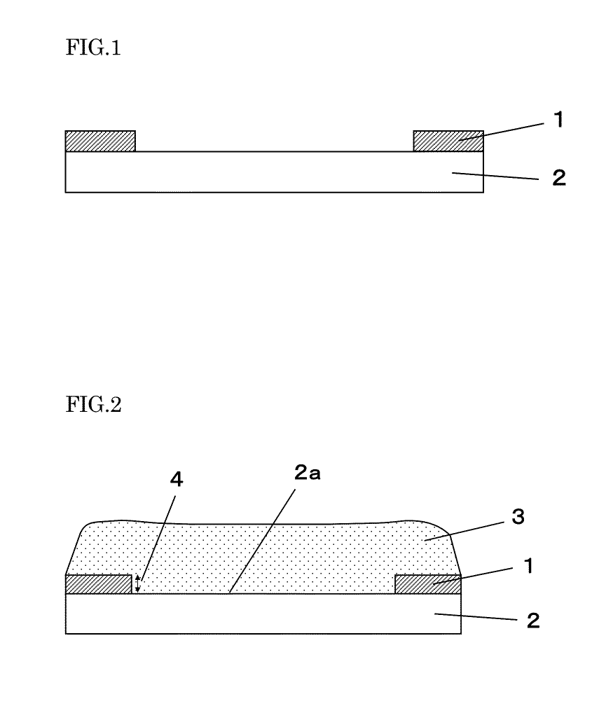

First of all, as shown in FIG. 1, a light-transmitting cover member 2 having a light-shielding layer 1 on the periphery of one surface thereof is prepared, and as shown in FIG. 2, a photocurable resin composition layer 3 is formed on a surface 2a of the light-transmitting cover member 2.

Specifically, so as to embed a level difference 4 formed by the light-shielding layer 1 and the surface 2a of the light-transmitting cover member 2 on the light-shielding layer forming side thereof, it is preferred that the photocurable resin composition layer 3 is formed flat in a thickness thicker than the light-shielding layer 1 on the entire surface of the surface 2a of the light-transmitting cover member 2 on the light-shielding layer forming side thereof inclusive of the surface of the light-shielding layer 1. It is to be noted that it is not always required that the photocurable resin composition layer 3 is formed flat. As shown in FIG. 4, in the case of sticking the light-transmitting cover member 2 and an image display member 6 to each other, a light-transmitting cured resin layer 5 formed by curing the photocurable resin composition layer 3 may be formed so as to be embedded in gaps between the image display member 6 and the light-shielding layer 1 and between the image display member 6 and the light-transmitting cover member 2.

A thickness of the light-transmitting cured resin layer between the light-transmitting cover member 2 and the image display member 6, which is obtained by curing the photocurable resin composition layer 3 upon irradiation with an active energy ray, such as an ultraviolet ray, etc., is preferably 6 μm or more, more preferably 15 μm or more, still more preferably 20 μm or more, especially preferably 50 μm or more, and extremely preferably 1.0×10² μm or more, and preferably 1.5×10³ μm or less, more preferably 1.0×10³ μm or less, and still more preferably 5.0×10² μm or less.

Examples of a method of forming the photocurable resin composition layer 3 include screen printing, metal mask printing, general coating with a slit coater, a bar coater, or the like, dispense with multi-nozzles (those in which nozzles of a dispenser are innumerably laid transversely), and the like. The photocurable resin composition layer 3 may be formed by adopting at least one of these methods, so as to obtain the required thickness. The formation of the photocurable resin composition layer 3 may be performed plural times so as to obtain the required thickness.

As for the light-transmitting cover member 2, it may have light transmissibility such that an image formed in the image display member is viewable, and examples thereof include plate-like or sheet-like materials of glass, an acrylic resin, polyethylene terephthalate, polyethylene naphthalate, polycarbonate, or the like.

These materials may be subjected to a single-side or double-side hard coating treatment, an antireflection treatment, or the like. A thickness and physical properties, such as elasticity, etc., of the light-transmitting cover member 2 may be properly determined depending upon the purposes of use. The light-transmitting cover member 2 may include a touch sensor layer, a parallax barrier layer for use in a naked eye 3D display device, and the like.

The light-shielding layer 1 is provided for the purpose of increasing the contract of an image and is one obtained by coating a paint colored in a black color or the like by a screen printing method or the like, followed by drying and curing.

A thickness of the light-shielding layer 1 is generally 5 μm to 1.0×10² μm, and the thickness is corresponding to the level difference 4.

### <Step (II) (Curing Step)>

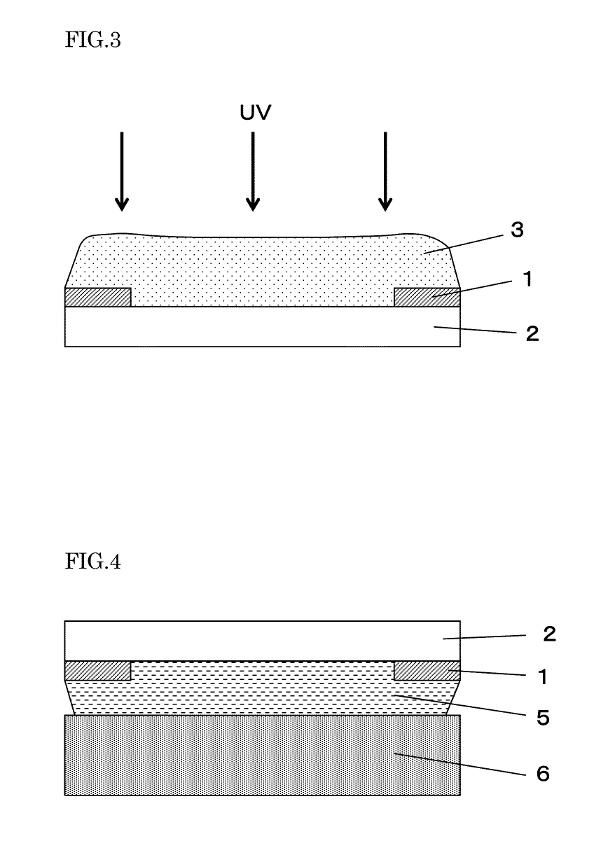

Subsequently, as shown in FIG. 3, the photocurable resin composition layer 3 formed in the step (I) is cured upon irradiation with an active energy ray, such as an ultraviolet ray, etc., thereby forming the light-transmitting cured resin layer 5.

A curing rate (gel fraction) of the light-transmitting cured resin layer 5 is a value as measured by a method shown in the Examples as described later, and the curing rate is preferably 80% or more, more preferably 90% or more, and still more preferably 95% or more.

A kind, an output, a cumulative quantity of light, and the like of the light source of the active energy ray, such as an ultraviolet ray, etc., are not particularly limited so long as curing can be performed such that the curing rate (gel fraction) is 80% or more, and known photo-radical polymerization process conditions of (meth)acrylates upon irradiation with an active energy ray, such as an ultraviolet ray, etc., may be adopted.

A waiting time of transition of from the step (I) (forming step of the photocurable resin composition layer 3) to the step (II) (curing step), namely, an interval of from completion of the formation of the photocurable resin composition layer to irradiation with an active energy ray, is preferably within 60 seconds, more preferably within 30 seconds, still more preferably within 10 seconds, and especially preferably within 5 seconds. When the interval of from completion of the formation of the photocurable resin composition layer to irradiation and exposure with an active energy ray is within 60 seconds, it is possible to prevent occurrence of the matter that smoothness is not obtainable since a coating end part of the photocurable resin composition becomes thick due to a surface tension.

### <Step (III) (Sticking Step)>

Subsequently, as shown in FIG. 4, the light-transmitting cover member 2 is stuck to the image display member 6 from the side of the light-transmitting cured resin layer 5 thereof. The sticking may be performed using a known compression bonding apparatus by pressurization at a temperature of, for example, 10° C. to 80° C.

Examples of the image display member 6 may include a liquid crystal display panel, an organic EL display panel, a plasma display panel, a touch panel, and the like. The touch panel as referred to herein means an image display and input panel in which a display element, such as a liquid crystal display panel, and a position input device, such as a touch pad, are combined.

The level of light transmissivity of the light-transmitting cured resin layer 5 may be light-transmissive to such extent that an image formed in the image display member 6 is viewable.

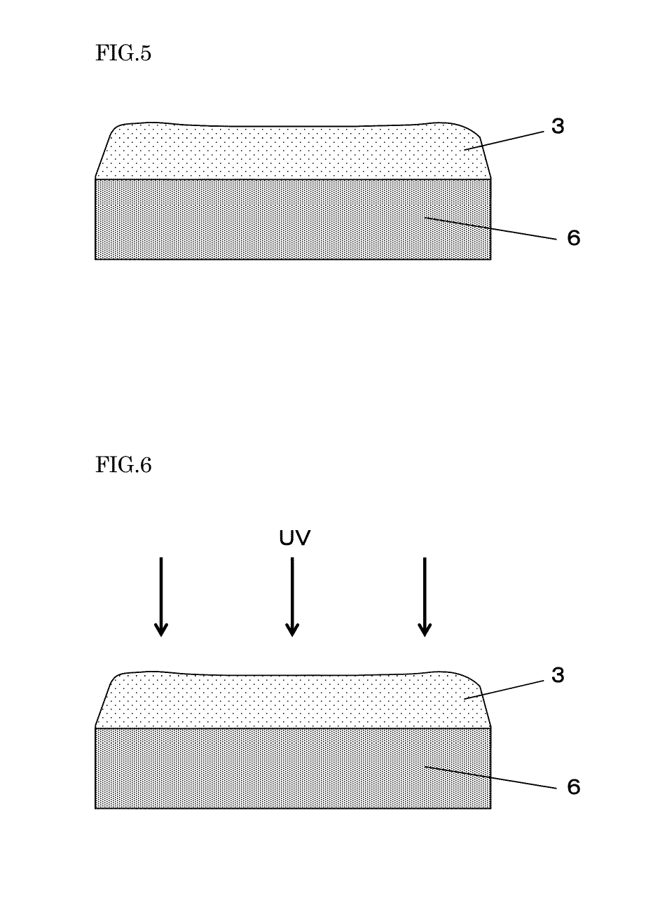

In the light of the above, in FIGS. 1 to 4, an embodiment in which the photocurable resin composition layer is formed on the surface of the light-transmitting cover member on the light-shielding layer forming side thereof has been described. However, in the following FIGS. 5 to 7, an embodiment in which the photocurable resin composition layer is formed on the surface of the image display member is shown. It is to be noted that in FIGS. 1 to 4 and FIGS. 5 to 7, the same figure numbers represent the same constituent elements.

In addition, a method of forming the photocurable resin composition layer on the surface side of the image display member is also included in the step (I); however, in the following explanation expressing an example thereof, in order to make distinction from the aforementioned explanation, the steps are described as steps (Ir) to (IIIr).

### <Step (Ir) (Forming Step of Photocurable Resin Composition Layer)>

First of all, as shown in FIG. 5, a photocurable resin composition layer 3 is formed on a surface of an image display member 6.

Here, it is not always required that the photocurable resin composition layer 3 to be formed on the image display member 6 is formed flat; however, from the viewpoint of stably performing the subsequent steps, the photocurable resin composition layer 3 is preferably flat.

In this case, a thickness of the photocurable resin composition layer 3 to be formed is preferably 6 μm or more, more preferably 15 μm or more, still more preferably 20 μm or more, especially preferably 50 μm or more, and extremely preferably 1.0×10² μm or more, and preferably 1.5×10³ μm or less, more preferably 1.0×10³ μm or less, and still more preferably 5.0×10² μm or less.

As an example of a method of forming the photocurable resin composition layer 3, the known methods exemplified in the aforementioned step (1) may be adopted. The formation of the photocurable resin composition layer 3 may be performed plural times so as to obtain the required thickness.

### <Step (IIr) (Curing Step)>

Subsequently, as shown in FIG. 6, the photocurable resin composition layer 3 formed in the step (Ir) is cured upon irradiation with an active energy ray, such as an ultraviolet ray, etc., thereby forming a light-transmitting cured resin layer 5.

A curing rate (gel fraction) of the light-transmitting cured resin layer 5 is preferably 80% or more, more preferably 90% or more, and still more preferably 95% or more.

### <Step (IIIr) (Sticking Step)>

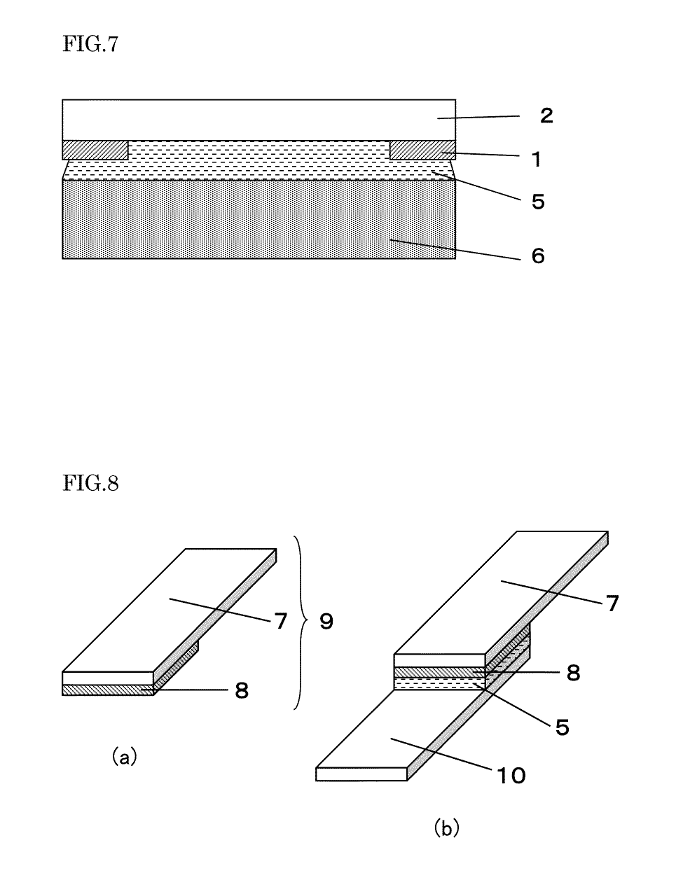

Subsequently, as shown in FIG. 7, a light-transmitting cover member 2 is stuck to the light-transmitting cured resin layer 5 of the image display member 6 from the side of a light-shielding layer 1 thereof.

Specifically, it is preferred that the image display member 6 having the light-transmitting cured resin layer 5 formed thereon and the light-transmitting cover member 2 having the light-shielding layer 1 formed thereon are stuck to each other such that the light-transmitting cured resin layer 5 is embedded in gaps between the image display member 6 and the light-shielding layer 1 and between the image display member 6 and the light-transmitting cover member 2.

The sticking may be performed using a known compression bonding apparatus by pressurization at a temperature of, for example, 10° C. to 80° C.

Examples of the image display member 6 may include a liquid crystal display panel, an organic EL display panel, a plasma display panel, a touch panel, a parallax barrier panel, and the like.

The level of light transmissivity of the light-transmitting cured resin layer 5 may be light-transmissive to such extent that an image formed in the image display member 6 is viewable.

### [Image Display Device]

The image display device according to the present invention includes a cured product of the photocurable resin composition according to the present invention.

The image display device according to the present invention is not particularly limited so long as it is one including a cured product of the photocurable resin composition according to the present invention, and examples thereof include image display devices which are obtained by the method for manufacturing an image display device according to the present invention.

### EXAMPLES

The present invention is specifically described below with reference to Examples and Comparative Examples, but it should not be construed that the present invention is limited to the following Examples. It is to be noted that in the Examples and Comparative Examples, respective properties and the like of photocurable resin compositions and cured products thereof were measured and evaluated by the following methods.

### [Evaluation Methods]

### <Viscosity of Photocurable Resin Composition>

A viscosity at 25° C. of a photocurable resin composition obtained in each of the Examples and Comparative Examples was measured in conformity with JIS Z8803. Specifically, the viscosity was measured by a B-type viscometer (a trade name: BL2, manufactured by Toki Sangyo Co., Ltd.). The calibration of the viscometer was performed in conformity with JIS Z8809-JS14000.

### <Curing Rate of Photocurable Resin Composition>

The curing rate (gel fraction) of the present invention is a numerical value as defined in terms of a proportion of a consumption of a (meth)acryloyl group as calculated from an abundance of the (meth)acryloyl group in the photocurable resin composition layer after irradiation with an ultraviolet ray relative to an abundance of the (meth)acryloyl group in the photocurable resin composition layer before irradiation with an ultraviolet ray, and it is meant that when the numerical value is larger, the curing is more advanced.

A curing rate (gel fraction) of the photocurable resin composition layer in each of a sample for evaluation of optical properties and a glass joined body for evaluation of adhesive force as described later was measured by performing an analysis of the photocurable resin composition layer before and after curing by means of attenuated total reflection (ATR) with a Fourier transform infrared (FT-IR) spectrophotometer (a trade name: Spectrum One, manufactured by Perkin Elmer Co., Ltd.).

Specifically, the curing rate was calculated by substituting an absorption peak height (X) at 800 cm⁻¹ to 820 cm⁻¹ from a base line in an FT-IR measurement chart of the photocurable resin composition layer before irradiation with an ultraviolet ray, an absorption peak height (Y) at 800 cm⁻¹ to 820 cm⁻¹ from a base line in an FT-IR measurement chart of the photocurable resin composition layer after irradiation with an ultraviolet ray at a dose as described later, and an absorption peak height (Z) at 800 cm⁻¹ to 820 cm⁻¹ from a base line in an FT-IR measurement chart of the photocurable resin composition layer after irradiation with an ultraviolet ray at 2.0×10⁴ mJ/cm² into the following numerical formula.

Curing rate (%)={(X−Y)/(X−Z)}×100 (1)

### <Evaluation of Optical Properties>

On a surface-polished glass having a thickness of 700 μm (a trade name: AN100, manufactured by Asahi Glass Co., Ltd.) (hereinafter also referred to as “AN100”), the photocurable resin composition obtained in each of the Examples and Comparative Examples was coated in a film thickness of 200 μm. Subsequently, an ultraviolet ray was irradiated at 1.0×10⁴ mJ/cm² by using an ultraviolet ray irradiator (a trade name: US5-X0401, manufactured by Eye Graphics Co., Ltd.) equipped with, as a light source, a metal halide lamp (a trade name: M04-L41, manufactured by Eye Graphics Co., Ltd.) to cure the photocurable resin composition, thereby fabricating a sample for evaluation of optical properties having the light-transmitting cured resin layer formed on the surface-polished glass. The formed light-transmitting cured resin layer had a curing rate of 100%.

A transmittance at a wavelength of 400 nm and b* of the sample were measured with a color difference meter (a trade name: Σ90, manufactured by Nippon Denshoku Industries Co., Ltd.) while using AN100 as a reference and evaluated according to the following criteria.

A: The transmittance at 400 nm was 98% or more, and the b* value was 1.0 or less.

F: The transmittance at 400 nm was less than 98%, or the b* value was more than 1.0.

### <Evaluation of Adhesive Force (Glass Coating)>

First of all, as shown in FIG. 8(a), a glass/polarizing plate laminate 9 in which a polarizing plate 8 was laminated on a glass base 7 having a size of 26 mm (width)×76 mm (length)×0.2 mm (thickness) was prepared.

Subsequently, the photocurable resin composition obtained in each of the Examples and Comparative Examples was coated on a glass base 10 of 26 mm (width)×76 mm (length)×0.2 mm (thickness), and an ultraviolet ray was irradiated at 1.0×10⁴ mJ/cm² by using the aforementioned ultraviolet ray irradiator to cure the photocurable resin composition layer, thereby preparing the glass base 10 having the light-transmitting cured resin layer 5 formed on one surface thereof.

Subsequently, as shown in FIG. 8(b), the glass base 10 having the light-transmitting cured resin layer 5 formed thereon was stuck to the side of the polarizing plate 8 of the glass/polarizing plate laminate 9 from the side of the light-transmitting cured resin layer 5 in such a manner that short sides of the glass base 7 and the glass base 10 were parallel to each other, thereby obtaining a glass joined body.

An area of the adhesive portion of the glass joined body was set to 26 mm×20 mm (520 mm²), and a thickness of the light-transmitting cured resin layer 5 was set to 0.2 mm. A curing rate of the light-transmitting cured resin layer 5 on the occasion of performing light irradiation before sticking was 100%.

The glass base 7 of the resulting glass joined body was immobilized in such a manner that its long sides were perpendicular to the ground, and its stuck portion to the glass base 10 was faced downward in the vertical direction. Subsequently, a load of 500 g was applied to the glass base 10 downward in the vertical direction, and a shape change after 24 hours was observed and evaluated according to the following criteria.

A: The shape change was not confirmed.

F: A position deviation between the glass/polarizing plate laminate 9 and the glass base 10 was confirmed.

### <Evaluation of Adhesive Force (Polarizing Plate Coating)>

The photocurable resin composition obtained in each of the Examples and Comparative Examples was coated on the glass base 7 of 26 mm (width)×76 mm (length)×0.2 mm (thickness) on the side of the polarizing plate 8 on the glass/polarizing plate laminate 9 having the polarizing plate 8 laminated thereon, and an ultraviolet ray was irradiated at 1.0×10⁴ mJ/cm² by using the aforementioned ultraviolet ray irradiator to cure the photocurable resin composition layer, thereby preparing the glass/polarizing plate laminate 9 having the light-transmitting cured resin layer 5 formed thereon.

Subsequently, as shown in FIG. 8(b), the glass/polarizing plate laminate 9 was stuck to the glass base 10 having a size of 26 mm (width)×76 mm (length)×0.2 mm (thickness) from the side of the light-transmitting cured resin layers in such a manner that short sides of the glass base 7 and the glass base 10 were parallel to each other, thereby obtaining a glass joined body.

An area of the adhesive portion of the glass joined body was set to 26 mm×20 mm (520 mm²), and a thickness of the light-transmitting cured resin layer 5 was set to 0.2 mm. A curing rate of the light-transmitting cured resin layer 5 on the occasion of performing light irradiation before sticking was 100%.

The glass base 7 of the resulting glass joined body was immobilized in such a manner that its long sides were perpendicular to the ground, and its stuck portion to the glass base 10 was faced downward in the vertical direction. Subsequently, a load of 500 g was applied to the glass base 10 downward in the vertical direction, and a shape change after 24 hours was observed and evaluated according to the following criteria.

A: The shape change was not confirmed.

F: A position deviation between the glass/polarizing plate laminate 9 and the glass base 10 was confirmed.

### <Evaluation of Liquid Floating>

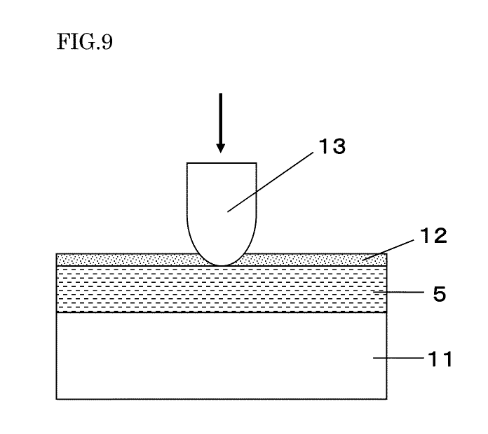

As shown in FIG. 9, the light-transmitting cured resin layer 5 of a sample obtained by cutting out the aforementioned sample for evaluation of optical properties in a size of 30 mm×30 mm was finger-touched and evaluated according to the following criteria. The temperature when the evaluation was performed was 25±5° C.

A: The sample was free from liquid floating and sticky, and the sample attached to the finger.

F: The sample did not attach to the finger, and only a liquid oozed out on the sample surface attached to the finger.

### [Raw Materials]

### <Component (A): Compound Having a (Meth)Acryloyl Group>

“UC-102”: Manufactured by Kuraray Co., Ltd., having the structure represented by the foregoing general formula (1), wherein R¹ is a methyl group, and n is 2 (number of methacryloyl group: 2), and having an Mn of 17,000

“UC-203”: Manufactured by Kuraray Co., Ltd., having the structure represented by the foregoing general formula (1), wherein R¹ is a methyl group, and n is 3 (number of methacryloyl group: 3), and having an Mn of 35,000

“FA-513AS”: Dicyclopentanyl acrylate, manufactured by Hitachi Chemical Company, Ltd.

“FA-512M”: Dicyclopentenyloxyethyl methacrylate, manufactured by Hitachi Chemical Company, Ltd.

“LIGHT ACRYLATE IB-XA”: Isobornyl acylate, manufactured by Kyoeisha Chemical Co., Ltd.

“LIGHT ESTER IB-XM”: Isobornyl methacylate, manufactured by Kyoeisha Chemical Co., Ltd.

### <Component (B): Photopolymerization Initiator>

“LUCIRIN TPO”: 2,4,6-Trimethylbenzoyl-diphenyl-phosphine oxide, manufactured by BASF Japan Ltd.

“IRGACURE 184”: 1-Hydroxy-cyclohexyl-phenyl-ketone, manufactured by BASF Japan Ltd.

“DAROCUR 1173”: 2-Hydroxy-2-methyl-1-phenyl-propan-1-one, manufactured by BASF Japan Ltd.

“DAROCUR MBF”: Phenylglyoxylic acid methyl ester, manufactured by BASF Japan Ltd.

### <Component (C): Plasticizer>

“G-1000”: Terminal hydroxyl group-containing polybutadiene, manufactured by Nippon Soda Co., Ltd.

“B-2000”: Polybutadiene, manufactured by Nippon Soda Co., Ltd.

“G-3000”: Terminal hydroxyl group-containing polybutadiene, manufactured by Nippon Soda Co., Ltd.

### <Component (D): Antioxidant>

“IRGANOX 1135”: Benzenepropanoic acid, 3,5-bis(1,1-dimethylethyl)-4-hydroxy, C7-C9 side chain alkyl ester, manufactured by BASF Japan Ltd.

“AO-503”: Di(tridecyl)-3,3′-thiodipropionate, manufactured by Adeka Corporation

### Examples 1 to 13 and Comparative Examples 1 to 4

The aforementioned components (A) to (D) as the raw materials were compounded in a compounding composition (% by mass) shown in Table 1 and heated and mixed with stirring at 90° C. for 30 minutes, thereby preparing photocurable resin compositions of Examples 1 to 13 and Comparative Examples 1 to 4. The numerical values regarding the components (A) to (D) in Table 1 mean % by mass relative to a total amount of the photocurable resin composition.

TABLE 1

| | | | Example | | | | | | | | | | | | | Comparative Example | | | |
|---|---|---|---|---|---|---|---|---|---|---|---|---|---|---|---|---|---|---|---|
| Component name | | | 1 | 2 | 3 | 4 | 5 | 6 | 7 | 8 | 9 | 10 | 11 | 12 | 13 | 1 | 2 | 3 | 4 |
| Compounding composition *1 | | | | | | | | | | | | | | | | | | | |
| Component | Component | UC-102 | 19.32 | 19.32 | 19.32 | 19.32 | 19.32 | 19.32 | 19.32 | — | 19.32 | 19.32 | 19.32 | 19.32 | 19.32 | 19.70 | 18.26 | — | — |
| (A) | (A1) | UC-203 | — | — | — | — | — | — | — | 11.57 | — | — | — | — | — | — | — | 11.79 | 10.96 |
| | Component | FA-513AS | 12.56 | 12.56 | 12.56 | 13.36 | — | — | 12.56 | — | — | — | — | — | — | 12.81 | 11.87 | — | — |
| | (A2) | FA-512M | 13.04 | 13.04 | 13.04 | 13.04 | 23.40 | 25.60 | 13.04 | 13.89 | 13.04 | 13.04 | 26.60 | 27.60 | 21.40 | 13.30 | 12.33 | 14.15 | 13.16 |
| | | IB-XA | — | — | — | — | — | — | — | — | 12.56 | — | — | — | — | — | — | — | — |
| | | IB-XM | — | — | — | — | — | — | — | — | — | 12.56 | — | — | — | — | — | — | — |
| Component (B) | | LUCIRIN TPO | 5.80 | — | — | 5.00 | 8.00 | 5.80 | 5.80 | 5.56 | 5.80 | 5.80 | — | — | 10.00 | 3.94 | 10.96 | 3.77 | 10.53 |
| | | IRGACURE 184 | — | 5.80 | — | — | — | — | — | — | — | — | — | — | — | — | — | — | — |
| | | DAROCUR MBF | — | — | — | — | — | — | — | — | — | — | 4.50 | 3.00 | — | — | — | — | — |
| | | DAROCUR 1173 | — | — | 5.80 | — | — | — | — | — | — | — | — | — | — | — | — | — | — |
| Component (C) | | G-1000 | 47.34 | 47.34 | 47.34 | 47.34 | 47.34 | 47.34 | — | — | 47.34 | 47.34 | — | — | 47.34 | 48.28 | 44.75 | — | — |
| | | B-2000 | — | — | — | — | — | — | 47.34 | — | — | — | — | — | — | — | — | — | — |
| | | G-3000 | — | — | — | — | — | — | — | 67.13 | — | — | 47.34 | 47.34 | — | — | — | 68.40 | 63.60 |
| Component | Component | IRGANOX 1135 | 0.97 | 0.97 | 0.97 | 0.97 | 0.97 | 0.97 | 0.97 | 0.93 | 0.97 | 0.97 | 0.97 | 0.97 | 0.97 | 0.99 | 0.91 | 0.94 | 0.88 |
| (D) | (D1) | | | | | | | | | | | | | | | | | | |
| | Component | AO-503 | 0.97 | 0.97 | 0.97 | 0.97 | 0.97 | 0.97 | 0.97 | 0.93 | 0.97 | 0.97 | 0.97 | 0.97 | 0.97 | 0.99 | 0.91 | 0.94 | 0.88 |
| | (D2) | | | | | | | | | | | | | | | | | | |

| | | | | | | | | | | | | | | | | | |
|---|---|---|---|---|---|---|---|---|---|---|---|---|---|---|---|---|---|
| Total mass of photocurable resin | 100 | 100 | 100 | 100 | 100 | 100 | 100 | 100 | 100 | 100 | 100 | 100 | 100 | 100 | 100 | 100 | 100 |
| composition | | | | | | | | | | | | | | | | | |
| (% by mass) | | | | | | | | | | | | | | | | | |
| Mass ratio: Component (A1)/ | 0.755 | 0.755 | 0.755 | 0.732 | 0.826 | 0.755 | 0.755 | 0.833 | 0.755 | 0.755 | 0.726 | 0.700 | 0.903 | 0.755 | 0.755 | 0.833 | 0.833 |
| Component (A2) | | | | | | | | | | | | | | | | | |
| Mass ratio: Component (B)/ | 0.129 | 0.129 | 0.129 | 0.109 | 0.187 | 0.129 | 0.129 | 0.218 | 0.129 | 0.129 | 0.098 | 0.085 | 0.246 | 0.086 | 0.258 | 0.145 | 0.436 |
| Component (A) | | | | | | | | | | | | | | | | | |
| Physical properties | | | | | | | | | | | | | | | | | |
| Viscosity (×10³ mPa · s) | 4.7 | 4.6 | 4.8 | 4.8 | 4.8 | 4.5 | 4.5 | 41 | 4.7 | 4.6 | 5.4 | 6.5 | 5.0 | 5.0 | 4.6 | 42 | 39 |
| Curing rate (%) *2 | 100 | 100 | 100 | 100 | 100 | 100 | 100 | 100 | 100 | 100 | 100 | 100 | 100 | 100 | 100 | 100 | 100 |
| Evaluation results | | | | | | | | | | | | | | | | | |
| Optical properties | A | A | A | A | A | A | A | A | A | A | A | A | A | A | A | A | A |
| Liquid floating | A | A | A | A | A | A | A | A | A | A | A | A | A | F | A | F | A |
| Adhesive force (polarizing plate coating) | A | A | A | A | A | A | A | A | A | A | A | A | A | F | F | F | F |
| Adhesive force (glass coating) | A | A | A | A | A | A | A | A | A | A | A | A | A | F | F | F | F |

*1 The numerical values of the components (A) to (D) each mean a content (% by mass) of each of the components relative to 100% by mass of a total amount of the photocurable resin composition.
*2 The curing rate means a curing rate (%) of the photocurable resin composition in the sample used for the evaluation of each of optical properties, liquid floating, adhesive force (polarizing plate coating), and adhesive force (glass coating).

It is noted from Table 1 that in the photocurable resin compositions of Examples 1 to 13, in particular, by adjusting the content of the photopolymerization initiator within the range of the present invention, the light-transmitting cured resin layer before sticking the image display member and the light-transmitting cover member to each other is free from liquid floating without requiring a post-step, and the adhesive force after sticking the aforementioned members to each other via the light-transmitting cured resin layer is favorable.

### INDUSTRIAL APPLICABILITY

The photocurable resin composition, the image display device using the same, and the method for manufacturing an image display device according to the present invention are useful for industrial manufacture of information terminals, such as a touch panel, a smartphone provided with a parallax barrier layer for use in a naked eye 3D display device, a touch pad, a personal computer, a television set, and the like.

### REFERENCE SIGNS LIST

1: Light-shielding layer
2: Light-transmitting cover member
2a: Surface of light-transmitting cover member on the light-shielding layer forming side thereof
3: Photocuring resin composition layer
4: Level difference
5: Light-transmitting cured resin layer
6: Image display member
7: Glass base
8: Polarizing plate
9: Glass/polarizing plate laminate
10: Glass base
11: Surface-polished glass
12: Liquid oozed out
13: Finger

1. A photocurable resin composition comprising (A) a compound having a (meth)acryloyl group, (B) a photopolymerization initiator, and (C) a plasticizer, a content of the photopolymerization initiator (B) being 4.0 to 10% by mass.

2. The photocurable resin composition according to claim 1, wherein an isoprene polymer having a (meth)acryloyl group is contained as the compound (A) having a (meth)acryloyl group.

3. The photocurable resin composition according to claim 1, wherein a content of the compound (A) having a (meth)acryloyl group is 10 to 90% by mass relative to a total amount of the photocurable resin composition.

4. The photocurable resin composition according to claim 1, wherein (A1) a polymer having a (meth)acryloyl group in a molecule thereof and (A2) a monomer having one (meth)acryloyl group in a molecule thereof are contained as the compound (A) having a (meth)acryloyl group.

5. The photocurable resin composition according to claim 4, wherein the monomer (A2) having one (meth)acryloyl group in a molecule thereof contains at least one (meth)acrylate having a dicyclopentanyl group, a dicyclopentenyl group, or an isobornyl group, and a content of the monomer (A2) having one (meth)acryloyl group in a molecule thereof is 10 to 40% by mass relative to a total amount of the photocurable resin composition.

6. The photocurable resin composition according to claim 1, further comprising (D) an antioxidant.

7. The photocurable resin composition according to claim 6, wherein the antioxidant (D) contains (D1) a compound having a hindered phenol structure and (D2) a compound having a thioether structure.

8. The photocurable resin composition according to claim 1, which has a viscosity at 25° C. of 5.0×10² mPa·s to 5.0×10⁴ mPa·s.

9. A method for manufacturing an image display device including an image display member and a light-transmitting cover member having a light-shielding layer formed on the periphery thereof, the image display member and the light-transmitting cover member being laminated via a light-transmitting cured resin layer formed of the photocurable resin composition according to claim 1 such that a light-shielding layer forming surface of the light-transmitting cover member is disposed on the side of the image display member, the method comprising the following steps (I) to (III), and in the step (II), the photocurable resin composition being cured upon irradiation with an active energy ray such that a curing rate of the light-transmitting cured resin layer is 80% or more,
Step (I): a step of subjecting the photocurable resin composition to layer formation on a surface of the light-transmitting cover member on the light-shielding layer forming side thereof, or a surface of the image display member on the light-shielding layer side thereof, to form a photocurable resin composition layer,
Step (II): a step of curing the formed photocurable resin composition layer upon irradiation with an active energy ray to form a light-transmitting cured resin layer, and
Step (III): a step of sticking the image display member and the light-transmitting cover member to each other so as to interpose the light-shielding layer and the light-transmitting cured resin layer between the image display member and the light-transmitting cover member.

10. The method for manufacturing an image display device according to claim 9, wherein in the step (I), the photocurable resin composition layer is formed on a surface of the light-transmitting cover member on the light-shielding layer forming side.

11. The method for manufacturing an image display device according to claim 9, wherein in the step (I), the photocurable resin composition layer is formed on a surface of the image display member.

12. The method for manufacturing an image display device according to claim 11, wherein in the step (III), the image display member having a light-transmitting cured resin layer formed thereon and the light-transmitting cover member having a light-shielding layer formed thereon are embedded in gaps formed between the image display member and the light-shielding layer and between the image display member and the light-transmitting cover member.

13. The method for manufacturing an image display device according to claim 9, wherein in the step (I), the photocurable resin composition layer is formed in a thickness of 6 μm to 1.5×10³ μm on a surface of the image display member or the light-transmitting cover member.

14. The method for manufacturing an image display device according to claim 9, wherein the image display member is a liquid crystal display panel, an organic EL display panel, a plasma display panel, a touch panel, or a parallax barrier panel.

15. An image display device comprising a cured product of the photocurable resin composition according to claim 1.
